(19) United States
(12) Patent Application Publication
(10) Pub. No.: US 2026/0316855 A1
(43) Pub. Date: Oct. 15, 2026

(54) TAPERED TRACK ROLLER FOR A TRACK LINK ASSEMBLY

(71) Applicant: Caterpillar Inc., Peoria, IL (US)

(72) Inventor: Gennaro SUANNO, Modena (IT)

(73) Assignee: Caterpillar Inc., Peoria, IL (US)

(21) Appl. No.: 19/178,226

(22) Filed: Apr. 14, 2025

(51) Int. Cl. B62D 55/15; B21K 1/02

(52) U.S. Cl. CPC B62D 55/14; B21K 1/28

(57) ABSTRACT

A roller for a track link assembly may include a first end surface, a second end surface, opposite to the first end surface, and a rim portion extending between the first end surface and the second end surface, the rim portion having a first tapered portion, adjacent to the first end surface, and tapering from the first end surface toward a center of the rim portion between the first end surface and the second end surface, and a second tapered portion, adjacent to the second end surface, and tapering from the second end surface toward the center of the rim portion.

### TECHNICAL FIELD

The present disclosure relates generally to a track link assembly, and, more particularly, to a tapered track roller for a track link assembly.

### BACKGROUND

Each track assembly of a track-type machine, such as a dozer, an excavator, or a skid-steer loader, includes a loop of interconnected track link assemblies, referred to as a track, that moves or rotates around an idler and roller assembly. The idler and roller assembly includes track rollers, or cylindrical wheels, that support the weight of the machine, guide and support the track link assemblies, and are positioned within the loop of track link assemblies. The track rollers include top track rollers and bottom track rollers. The top track rollers are located along the top of the track assembly, and prevent the track link assemblies from slipping off of the track (also referred to as slippage), during operation of machines in side-slope applications, and from sagging. The bottom track rollers are located along the bottom of the track assembly, and use bearings to displace loads along the track. Track rollers typically include one flange on an outer edge of the track roller (single flange (SF) track rollers), or two flanges, including one flange on the outer edge and one flange on an inner edge (double flange (DF) track rollers). The flanges help maintain alignment of the track assemblies and help prevent the track links from slipping (that is, moving toward and off longitudinal ends of the track rollers. Idler and roller assemblies typically include, in addition to idlers, a combination of SF track rollers and DF track rollers (a SF and DF arrangement), specifically, for example, eight (8) SF track rollers and eight (8) DF track rollers, in an alternating arrangement. Track rollers may be formed by, for example, forging, however, the SF and DF track rollers in particular are relatively more complex and more expensive to manufacture, because such rollers require an additional step, after forging, of making an undercut to form the inner and/or outer flange. Further, relatively larger blanks (that is, relatively more starting material) may be needed to form DF track rollers to ensure the final product is of sufficient size following the manufacturing process.

U.S. Pat. No. 11,186,330 describes a track assembly having a plurality of wheels, including a drive wheel and roller wheels, and an endless track disposed around the wheels for engaging the ground. A roller wheel includes a wheel body and a covering on the wheel body, with the covering comprising a lateral portion dimensioned to contact a drive/guide lug of the track. The roller wheels and the track are self-aligning, in that two rollers exert lateral forces inward towards a portion of a track located between the rollers, thereby aligning the track between the two rollers. The track assembly of the '330 patent thus requires two rollers to maintain alignment of a single track. The rollers of the track assemblies of the '330 patent do not address problems associated with the need for a roller and, in turn, a track link assembly that is relatively less expensive and less complex to manufacture.

The tapered track roller, and the related track roller assembly and method of manufacture of the present disclosure may solve one or more of the problems set forth above and/or other problems in the art. The scope of the current disclosure, however, is defined by the attached claims, and not by the ability to solve any specific problem.

### SUMMARY

In one aspect, the invention is directed to a roller for a track link assembly, the roller comprising: a first end surface; a second end surface, opposite to the first end surface; and a rim portion extending between the first end surface and the second end surface, the rim portion having: a first tapered portion, adjacent to the first end surface, and tapering from the first end surface toward a center of the rim portion between the first end surface and the second end surface; and a second tapered portion, adjacent to the second end surface, and tapering from the second end surface toward the center of the rim portion.

In another aspect, the invention is directed to a roller assembly for a track link assembly, the roller assembly comprising: a roller having: a first end surface; a second end surface, opposite to the first end surface; a rim portion extending between the first end surface and the second end surface, the rim portion having: a first tapered portion, adjacent to the first end surface, and tapering from the first end surface toward a center of the rim portion between the first end surface and the second end surface; and a second tapered portion, adjacent to the second end surface, and tapering from the second end surface toward the center of the rim portion; and a central through-hole, extending longitudinally from the first end surface to the second end surface; and a shaft, extending through the central through-hole, the shaft rotatably supporting the roller.

In still another aspect, the invention is directed to a method of manufacturing a roller assembly for a track link assembly, the method comprising: providing a cylindrical blank; and precision forging the cylindrical blank to form a roller having: a first end surface; a second end surface, opposite to the first end surface; and a rim portion extending between the first end surface and the second end surface, the rim portion having: a first tapered portion, adjacent to the first end surface, and tapering from the first end surface toward a center of the rim portion located between the first end surface and the second end surface; and a second tapered portion, adjacent to the second end surface, and tapering from the second end surface toward the center of the rim portion.

### BRIEF DESCRIPTION OF THE DRAWINGS

FIG. 1 shows a side view of a dozer, as an example of a track-type machine, having track link assemblies, each including a tapered track roller, in accordance with the present disclosure.

FIG. 2 shows a schematic side view of a tapered track roller, as part of a track roller assembly, and track links, in accordance with the present disclosure.

FIG. 3 shows an isometric view of the tapered track roller, shown in FIG. 2, in accordance with the present disclosure.

FIG. 4 shows an isometric view of the track roller assembly, shown in FIG. 2, in accordance with the present disclosure.

FIG. 5 is a flow chart of a method of manufacturing a tapered track roller, in accordance with the present disclosure.

FIG. 6 shows a schematic side view of an alternate configuration of a tapered track roller, in accordance with the present disclosure.

### DETAILED DESCRIPTION

Both the foregoing general description and the following detailed description are exemplary and explanatory only and are not restrictive of the features, as claimed. As used herein, the terms “comprises,” “comprising,” “having,” including,” or other variations thereof, are intended to cover a non-exclusive inclusion, such that a process, method, article, or apparatus that comprises a list of elements does not include only those elements, but may include other elements not expressly listed or inherent to such a process, method, article, or apparatus. Moreover, in this disclosure, relative terms, such as, for example, “about,” “generally, “substantially,” and “approximately” are used to indicate a possible variation of ±10% in the stated value.

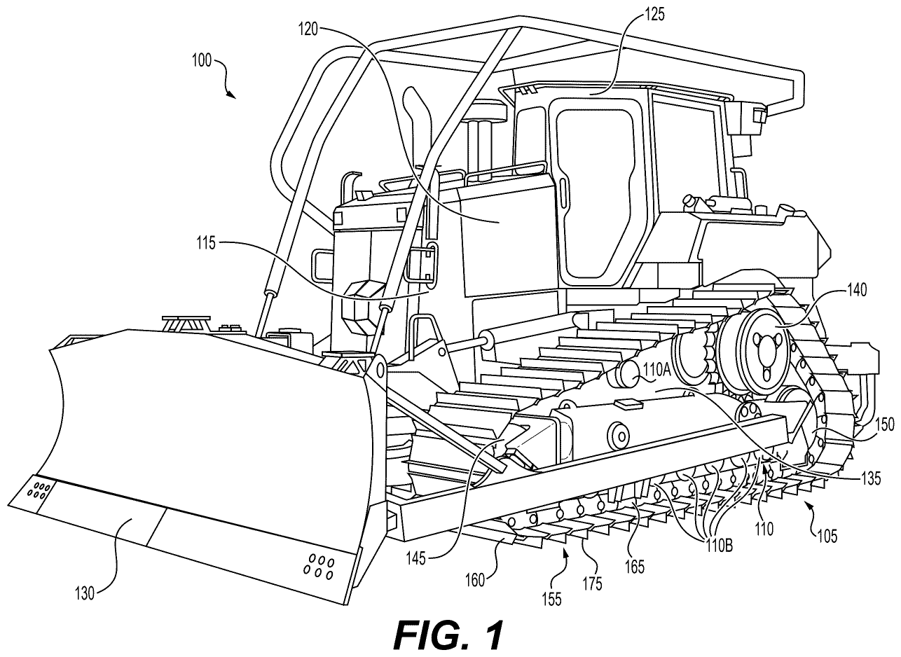

FIG. 1 shows a track-type machine 100 having two track assemblies 105 (only one shown), each including a plurality of tapered track rollers 110, in accordance with the present disclosure. The machine 100 also includes a machine frame 115 supporting an engine 120, an operator station (or cab) 125, a work tool 130, and a track support frame 135, provided as part of an undercarriage of the machine frame 115.

Each track assembly 105 includes a sprocket 140, a front idler 145, a rear idler 150, tapered track rollers 110, including at least one top track roller 110a and bottom track rollers 110b, and a plurality of track link assemblies 155 arranged in a loop or a track 160, around the sprocket 140, the front idler 145, the rear idler 150, and the tapered track rollers 110. The front idler 145 and the rear idler 150 aid in movement of the track 160, and help to maintain alignment of the track 160 and to maintain proper tension of the track 160. The top track roller 110a and the bottom track rollers support 110b the weight of the track 160 and help to maintain alignment of the track 160. The bottom track rollers 110b also minimize strain on the sprocket 140 and the idlers 145 and 150. The track assemblies 105, the work tool 130, sprockets 140, idlers 145 and 150, and the plurality of tapered track rollers 110 are all mounted to and supported by the track support frame 135.

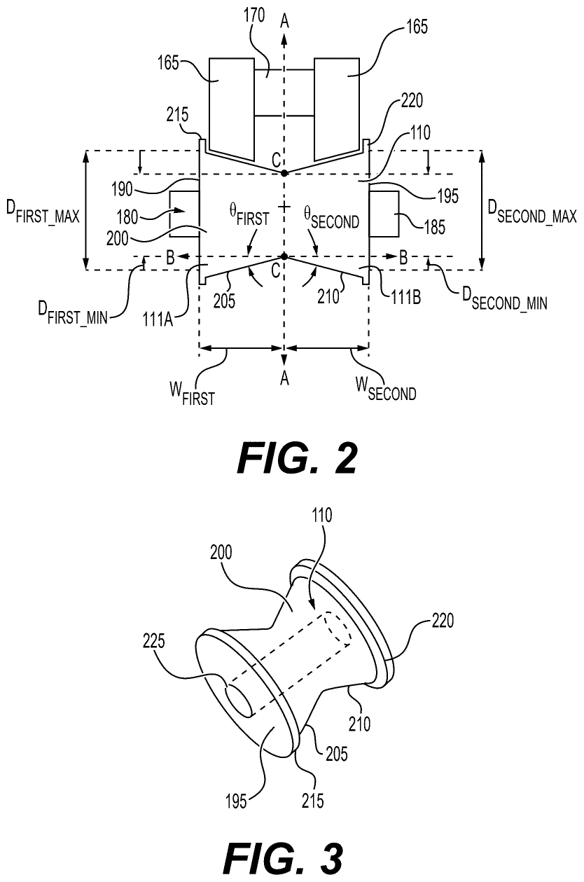

Each track link assembly 155 includes a pair of track links 165, connected to each other and to adjacent pairs of track links 165 using bushings 170 (shown in FIG. 2) and pins (not shown), and track shoes 175, connected to the track links 165 using bolts and nuts (not shown). During operation, the engine 120 is configured to generate a power output directed through the sprocket 140, which transmits a force to move the track 160, including the track link assemblies 155 and the track shoes 175, around the idlers 145 and 150 and the track rollers 110, to propel the machine 100 forwards or backwards with engagement of track shoes 175 of a segment of the track 160 with ground material.

FIG. 2 shows a schematic side view of a tapered track roller 110, as part of a track roller assembly 180, in accordance with the present disclosure. In particular, FIG. 2 shows the track roller assembly 180, including the tapered track roller 110 and a shaft 185, on which the tapered track roller 110 is mounted. FIG. 2 also shows a pair of track links 165 connected by a bushing 170. The track links 165 may have a taper matching the taper of the tapered track roller 110, as shown in FIG. 2. Alternatively, the track links 165 may have a different angle of taper than that of the tapered track roller 110, or the track links 165 may be partially tapered and partially flat. The tapered track roller 110 has a first end surface 190, a second end surface 195 opposite to the first end surface, and a rim portion 200 extending or located between the first end surface 190 and the second end surface 195. The rim portion 200 has a first tapered portion 205, adjacent to the first end surface 190 of the track roller 110, and a second tapered portion 210, adjacent to the second end surface 195 of the track roller 110. The first tapered portion 205 tapers, or narrows, from the first end surface 190 toward a center line C-C of the rim portion 200, along an axis A-A and in a widthwise direction as shown in FIG. 2, between the first end surface 190 and the center line C-C. The second tapered portion 210 tapers from the second end surface 195 toward the center line C-C of the rim portion 200, in the widthwise direction between the first end surface 190 and the center line C-C. In an alternative embodiment, the first tapered portion 205 and the second tapered portion 210 may not extend to the center line, and instead, the tapered track roller 110 may have an intermediate portion (unshown) in between the first tapered portion 205 and the second tapered portion 210.

In one or more embodiments, the tapered track roller 110 may be formed of two portions, or two half-rims, namely, a first portion 111A and a second portion 111B. The first portion 111A and the second portion 111B may be joined along the center line C-C via welding, for example. Other means of attaching or joining the first portion 111A and the second portion 111B together may be used. The first portion 111A and the second portion 111B include the first tapered portion 205 and the second tapered portion 210, respectively, with surfaces of the first tapered portion 205 and the second tapered portion 210 contacting a track link 165.

In one or more embodiments, the tapered track roller 110 may include a first flange 215 on an end of the rim portion 200 nearest the first end surface 190, and a second flange 220 on an end of the rim portion 200 nearest the second end surface 195. The first flange 215 and the second flange 220 may be cylindrical and each may be integrally formed with the tapered track roller 110. In alternative embodiments, the track link roller 110 may include a single flange 215 (or 220) on one end of the tapered track roller 110, or no flanges. And, in other embodiments, more than one flange may be provided on one or both ends of the tapered track roller 110.

In the embodiment shown in FIG. 2, a width W_{FIRST} of the first tapered portion 205 and a width W_{SECOND} of the second tapered portion 210, both measured along a longitudinal axis B-B extending between the first end surface 190 and the second end surface 195, are equal. In addition, a difference Δ_{FIRST} of a maximum diameter D_{FIRST_MAX} and a minimum diameter D_{FIRST_MIN} of the first tapered portion 205 and a difference Δ_{SECOND} of a maximum diameter D_{SECOND_MAX} and a minimum diameter D_{SECOND_MIN} of the second tapered portion 210 are equal, such that a taper T_{FIRST} of the first tapered portion 205, defined as T_{FIRST}=Δ_{FIRST}/W_{FIRST}, and a taper T_{SECOND} of the second tapered portion 210, defined as T_{SECOND}=Δ_{FIRST}/W_{SECOND}, are equal. Further, in one or more embodiments, the taper T_{FIRST} and the taper T_{SECOND} may be linear. Still further, an angle θ_{FIRST} of the first tapered portion 205 relative to the axis B-B, as shown in FIG. 2, and an angle θ_{SECOND} of the second tapered portion 210 relative to the axis B-B are equal. In other embodiments, one or more of the follow may apply: the width W_{FIRST} and the width W_{SECOND} may be different from each other, the difference Δ_{FIRST} and the difference Δ_{SECOND} may be different from each other, the taper T_{FIRST} and the taper T_{SECOND} may be different from each other, one or both of the taper T_{FIRST} and the taper T_{SECOND} may be non-linear, including being partially or entirely curved, and the angle θ_{FIRST} and the angle θ_{SECOND} may be different from each other.

FIG. 3 shows an isometric view of the tapered track roller 110, in accordance with the present disclosure. In particular, FIG. 3 shows the tapered track roller 110 and a central through-hole 225, extending longitudinally from the first end surface 190 toward the second end surface. 195 The central through-hole 225 may have a circular cross-sectional shape. FIG. 3 also shows the first end surface 190 having a circular shape (shown in perspective view). The second end surface 195 (not shown in FIG. 3) may also have a circular shape. In addition, the rim portion 200 may have a cross-sectional shape in a plane between the first end surface 190 and the second end surface 195. That is, when viewed in any plane that is parallel to and between the first end surface 190 and the second end surface 195, the cross-sectional shape of the rim portion 200 may be a circle.

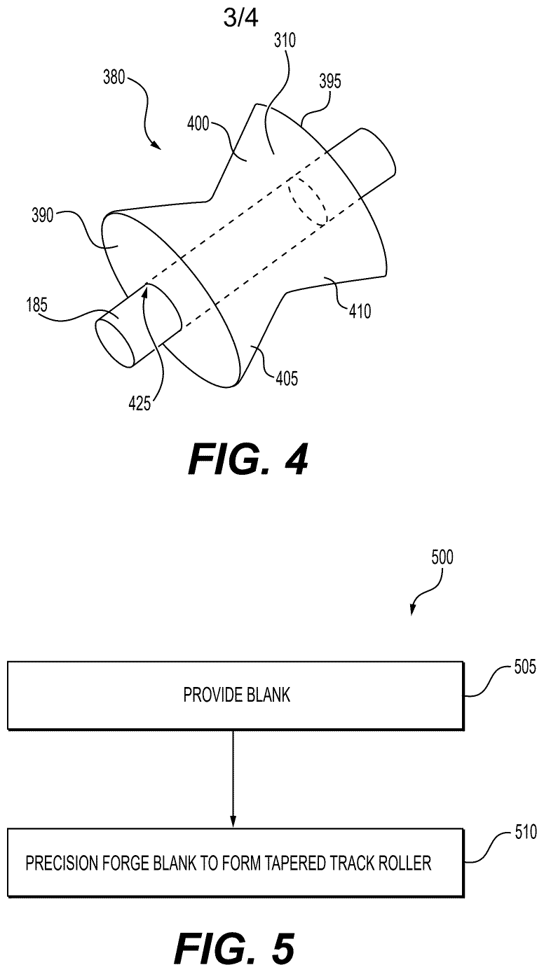

FIG. 4 shows an isometric view of a track roller assembly 380, in accordance with the present disclosure. The track roller assembly 380 includes a tapered track roller 310, which may have the same or similar parts as the tapered track roller 110 shown in FIGS. 2 and 3. The tapered track roller 310 of this embodiment includes a first end surface 390 and a second end surface 395, a rim portion 400 extending between the first end surface 390 and the second end surface 395, a first tapered portion 405 and a second tapered portion 410, and a central through-hole 425. The tapered track roller 310 of this embodiment differs from the tapered track roller 110 of the embodiment shown in FIGS. 2 and 3 in that it does not have flanges. The track roller assembly 380 also includes a shaft 185 on which the tapered track roller 310 is mounted. As shown in FIG. 4, the shaft 185 extends through the central through-hole 425 of the tapered track roller 310. Although FIG. 4 shows the tapered track roller 310 as part of the track roller assembly 380, the tapered track roller 110 may instead be used as part of the track roller assembly 380.

In the embodiments shown in FIGS. 2 to 4, the tapered track roller 110 includes two flanges (i.e., a first flange 215 on one end of the rim portion 200, and the second flange 220 on the other end of the rim portion 200 of the tapered track roller 110) and the tapered track roller 310 has no flanges. In other embodiments, however, a tapered track roller may have a single flange provided on one end (i.e., an outer end) of the tapered track roller.

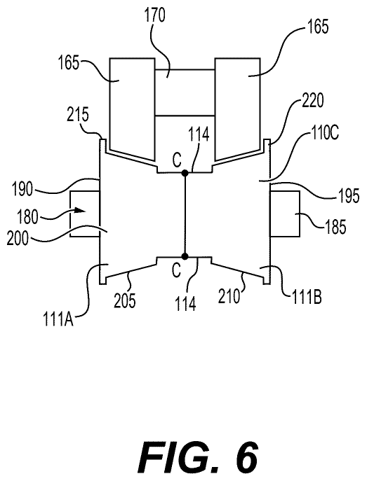

FIG. 6 shows a schematic side view of a tapered track roller 110C, which is an alternate configuration of track roller 110. As shown in FIG. 6, track roller 110C has features that correspond to those described with respect to FIG. 2. For example, track roller 110C may include a first portion 111A and a second portion 111B that are joined along center line C-C by welding, for example.

As shown in FIG. 6, portions 111A and 111B, once connected, form a cylindrical portion 114 that connects first tapered portion 205 to second tapered portion 210. Portion 114 may separate tapered portions 205 and 210 and form a cylindrical hub of track roller 110C. While portion 114 may be cylindrical, portion 114 may have other shapes, such as curved shapes that are symmetrical about center line C-C.

### INDUSTRIAL APPLICABILITY

The tapered track rollers 110 and 310, the related track roller assembly 380, and the related method 500 of manufacture of the present disclosure (discussed below) can be used in track-type machines 100, such as track-type tractors, dozers, excavators, and skid-steer loaders. Specifically, the tapered track rollers 110 and 310, in accordance with the present disclosure, can be used to form track roller assemblies 380 that support track link assemblies 155 as they rotate, in a loop or track 160, along with track shoes 175 attached thereto, to help propel the track-type machine 100 forwards or backwards.

Referring to FIGS. 2 to 4, in use, each of a plurality of tapered track rollers 110 (or 310) may be mounted onto a shaft 185, with each shaft 185 extending through the central through-hole 225 of the corresponding tapered track roller 110 (or 310). The shafts 185 may be mounted to the track support frame 135. During operation of the track-type machine 100, as the track 160 of track link assemblies 155, including track links 165 and track shoes 175, moves around in a loop, the track links 165 move across each tapered track roller 110 (or 310), with the tapered track rollers 110 (or 310), either as a top track roller 110a (or 310a) or a bottom track roller 110b (or 310b), supporting the track links 165 and, in turn, the track link assemblies 155, and maintaining alignment of the track links 165 relative to other track links 165 of the track 160 and relative to the track support frame 135. This arrangement helps to prevent misalignment and slipping of track link assemblies 155 during operation of the track-type machine 100.

FIG. 5 is a flow chart of a method 500 of manufacturing a tapered track roller 110 (or 310), in accordance with the present disclosure. The method 500 may include a first step 505 of providing a blank. The blank may be cylindrical and may be formed of, for example, commercial grade steel. The method 500 may also include a step 510 of precision forging the blank to form a roller 110 having a first end surface 190 (or 390), a second end surface 195 (or 395) opposite to the first end surface 190, and may include a rim portion 200 (or 400) extending between the first end surface 190 and the second end surface 195. The rim portion 200 may have, as a result of the precision forging, a first tapered portion 205 (or 405), adjacent to the first end surface 190, and tapering from the first end surface 190 toward a center line C-C of the rim portion 200 between the first end surface 190 and center line C-C, and a second tapered portion 210 (or 410), adjacent to the second end surface 195, and tapering from the second end surface 195 to the center line C-C of the rim portion 200.

The tapered track roller 110 (or 310) formed by the method 500 may have one or more of the features described herein with respect to the tapered track rollers 110 and 310 of FIGS. 2-4, including, for example, the width W_{FIRST} of the first tapered portion 205 and a width W_{SECOND} of the second tapered portion 210, both measured along an axis B-B extending between the first end surface 190 and the second end surface 195, being equal. As another example, the angle θ_{FIRST} of a taper T_{FIRST} of the first tapered portion 205, relative to the axis B-B, and the angle θ_{SECOND} of a taper T_{SECOND} of the second tapered portion 210, relative to the axis B-B, may be equal. As still another example, the taper T_{FIRST} of the first tapered portion 205 and the taper T_{SECOND} of the second tapered portion 210 may both be linear.

In the arrangement of FIGS. 2 and 3, the precision forging may include forming a first flange 215 on an edge of the first tapered portion 205 nearest the first end surface 190, and a second flange 220 on an edge of the second tapered portion 210 nearest the second end surface 195. However, as noted above and shown in FIG. 4, the flanges 215, 220 may be omitted and the taper portions may extend completely or approximately to the end surfaces 390 and 395. The rim portion 200 of the roller 110 formed by the method 500 may have a circular cross-section on a plane parallel to the first end surface 190 and the second end surface 195. In addition, the blank provided in the method 500 may have a central through-hole 225, such that the roller 110 has the central through-hole 225, and the method 500 may further include a step of inserting a shaft 185 through the central through-hole 225 of the roller 110, to thereby form a track roller assembly 180 including the tapered track roller 110 and the shaft 185.

By virtue of the tapered track roller 110 (or 310), and the related tapered track roller assembly 380 and method 500 of manufacture, as described herein, a track roller 110 capable of supporting and maintaining alignment of track link assemblies 155 of track-type machines 100 is provided, having a relatively less complex and a relatively less expensive method for manufacture. Specifically, the method 500 of manufacturing a track roller 110 in accordance with the present disclosure may provide a cost savings as compared to a cost of manufacturing known track rollers. Such savings may be attributed, as one example, to the need for relatively less starting material, that is, a smaller blank, since no additional steps like making undercuts are needed. Further, the first tapered portion 205 and the second tapered portion 210 of the tapered track roller 110, by themselves or with the first flange 215 and the second flange 220, may help prevent slippage of the track links 165 of the track link assemblies 155 during operation of the track-type machine 100, particularly during operation of machines 100 in side-slope applications. Still further, by virtue of the tapered track roller 110 described herein, a single track roller 110 may be used, rather than two track rollers arranged side-by-side, to maintain alignment of a track link assemblies 155 along the track 160 of the track-type machine 100. In addition, by virtue of using a single type of track roller, that is, the tapered track roller 110 of the present disclosure, there is no need for alternating track roller types, as in a SF and DF arrangement, which, in turn, simplifies the process of installing and replacing track rollers 110 on the track type machine 100.

It will be apparent to those skilled in the art that various modifications and variations can be made to the disclosed tapered track roller, track roller assembly, and method of manufacture, without departing from the scope of the disclosure. Other embodiments of the tapered track roller, track roller assembly, and method of manufacture will be apparent to those skilled in the art from consideration of the specification and the accompanying figures. It is intended that the specification, and, in particular, the examples provided herein be considered as exemplary only, with a true scope of the disclosure being indicated by the following claims and their equivalents.

1. A roller for a track link assembly, the roller comprising:
a first end surface;
a second end surface, opposite to the first end surface; and
a rim portion extending between the first end surface and the second end surface, the rim portion having:
a first tapered portion, adjacent to the first end surface, and tapering from the first end surface toward a center of the rim portion between the first end surface and the second end surface; and
a second tapered portion, adjacent to the second end surface, and tapering from the second end surface toward the center of the rim portion.

2. The roller of claim 1, wherein a width of the first tapered portion and a width of the second tapered portion, as measured along an axis extending between the first end surface and the second end surface, are equal.

3. The roller of claim 1, wherein an angle of a taper of the first tapered portion, relative to a longitudinal axis of the roller, and an angle of a taper of the second tapered portion, relative to the longitudinal axis of the roller, are equal.

4. The roller of claim 1, wherein a taper of the first tapered portion and a taper of the second tapered portion are linear.

5. The roller of claim 1, further comprising a central through-hole extending through the a center of the roller, from the first end surface to the second end surface.

6. The roller of claim 1, further comprising one or more of a first flange on an edge of the first tapered portion adjacent to the first end surface, or a second flange on an edge of the second tapered portion adjacent to the second end surface.

7. The roller of claim 1, wherein the rim portion has a circular cross-section on a plane parallel to the first end surface and the second end surface.

8. A roller assembly for a track link assembly, the roller assembly comprising:
a roller having:
a first end surface;
a second end surface, opposite to the first end surface;
a rim portion extending between the first end surface and the second end surface, the rim portion having:
a first tapered portion, adjacent to the first end surface, and tapering from the first end surface toward a center of the rim portion between the first end surface and the second end surface; and
a second tapered portion, adjacent to the second end surface, and tapering from the second end surface toward the center of the rim portion; and
a central through-hole, extending longitudinally from the first end surface to the second end surface; and
a shaft, extending through the central through-hole, the shaft rotatably supporting the roller.

9. The roller assembly of claim 8, wherein a width of the first tapered portion and a width of the second tapered portion, as measured along an axis extending between the first end surface and the second end surface, are equal.

10. The roller assembly of claim 9, wherein an angle of a taper of the first tapered portion, relative to a longitudinal axis of the roller, and an angle of a taper of the second tapered portion, relative to the longitudinal axis of the roller, are equal.

11. The roller assembly of claim 8, wherein a taper of the first tapered portion and a taper of the second tapered portion are linear.

12. The roller assembly of claim 8, wherein the roller further has a first flange on an edge of the first tapered portion adjacent to the first end surface, and a second flange on an edge of the second tapered portion adjacent to the second end surface.

13. The roller assembly of claim 8, wherein the rim portion has a circular cross-section on a plane parallel to the first end surface and the second end surface.

14. A method of manufacturing a roller assembly for a track link assembly, the method comprising:
providing a cylindrical blank; and
precision forging the cylindrical blank to form a roller having:
a first end surface;
a second end surface, opposite to the first end surface; and
a rim portion extending between the first end surface and the second end surface, the rim portion having:
a first tapered portion, adjacent to the first end surface, and tapering from the first end surface toward a center of the rim portion located between the first end surface and the second end surface; and
a second tapered portion, adjacent to the second end surface, and tapering from the second end surface toward the center of the rim portion.

15. The method of claim 14, wherein a width of the first tapered portion and a width of the second tapered portion, as measured along an axis extending between the first end surface and the second end surface, are equal.

16. The method of claim 14, wherein an angle of a taper of the first tapered portion, relative to a longitudinal axis of the roller, and an angle of a taper of the second tapered portion, relative to the longitudinal axis of the roller, are equal.

17. The method of claim 14, wherein a taper of the first tapered portion and a taper of the second tapered portion are linear.

18. The method of claim 14, wherein the precision forging includes forming one or both of a first flange on an edge of the first tapered portion nearest the first end surface, and a second flange on an edge of the second tapered portion nearest the second end surface.

19. The method of claim 14, wherein the rim portion has a circular cross-section on a plane parallel to the first end surface and the second end surface.

20. The method of claim 14, wherein the cylindrical blank includes a central through-hole and the roller includes the central through-hole following the precision forging, and wherein the method further comprises inserting a cylindrical shaft through the central through-hole, thereby forming the roller assembly.
